(19) United States
(12) Patent Application Publication
(10) Pub. No.: US 2021/0161327 A1
(43) Pub. Date: Jun. 3, 2021

(54) PACKAGE

(71) Applicant: SARONG SOCIETA' PER AZIONI, 42046 REGGIOLO (REGGIO EMILIA) (IT)

(72) Inventors: ANDREA BARTOLI, REGGIO EMILIA (IT); DAVIDE CAPITINI, REGGIO EMILIA (IT)

(21) Appl. No.: 17/045,646

(22) PCT Filed: Apr. 11, 2019
(86) PCT No.: PCT/IB2019/052982

§ 371 Date: Oct. 6, 2020

(30) Foreign Application Priority Data
Apr. 12, 2018 (IT) 102018000004427
Apr. 12, 2018 (IT) 102018000004437

(51) Int. Cl. A47J 31/40; B65D 21/02; B65D 85/804; B65D 53/08; B65D 77/20

(52) U.S. Cl. CPC A47J 31/407; B65D 21/0206; B65D 85/8046; B65D 85/8064; B65D 77/2024; B65D 85/8061; B65D 53/08

(57) ABSTRACT

A package (6) comprises a single capsule (2) is proposed. The package (6) comprises a covering element (7). The covering element (7) has larger dimensions than a maximum dimension of a mouth of the seat of the dispensing machine, so that a user is forced to detach the covering element (7) from the flanged rim (204) of the capsule (2) in order to be able to insert the capsule (2) in said seat. A package (1) comprising a plurality of capsules (2), wherein each capsule comprises a flanged rim extending from said side wall; and wherein said package comprises a single covering element (3); said covering element being detachably fixed to each flanged rim of each capsule so as to seal each cavity, such as to enable a user to detach a capsule from the covering element of the package and allow use of said capsule in the dispensing machine.

The invention relates to a package comprising at least one capsule or container for the preparation of products, for example beverages, in automatic dispensing machines.

In particular, the invention relates to a package comprising a single capsule, single-dose and disposable, containing an initial product able to realise, by interacting with pressurised fluid, a final product, for example a beverage.

The invention also relates to a package comprising capsules or containers for the preparation of products, for example beverages, in automatic dispensing machines.

In particular, the invention relates to a package comprising a plurality of capsules, each being single-dose and disposable and containing an initial product able to realise, by interacting with pressurised fluid, a final product, for example a beverage.

The known capsules for use in dispensing machines are disposable, single-dose containers comprising an outer casing and having the shape of a glass or cup. The casing usually has a base wall and a side wall defining a cavity containing the initial product, for example ground coffee or tea, from which the final product is to be obtained, for example the beverage. A flange-shaped rim extends from the side wall and is arranged around an opening of the cavity, arranged on the opposite side with respect to the base wall. The opening is sealed by a covering element, so as to seal the product inside the container, and is fixed to the rim of the casing. The base wall of the capsule can optionally have an opening defined by an edge of the base on which a further covering element is fixed.

The capsule is perforable to allow the entry of pressurised liquid, typically water, and the output of the coffee beverage produced.

For this reason, both the covering element and the base wall, or optionally the further covering element, are realised using a material that is easily perforable, allowing the capsule to be used with great flexibility of use in different dispensing machines.

In particular, in a first type of dispensing machine, the covering element and the base wall, or optionally the further covering element, are perforable respectively by a suitable injection device for injecting pressurised fluid and by a suitable extraction device of a dispensing machine to allow the entry of pressurised liquid and the extraction of the beverage. Typically, in these types of capsules, the injection device for injecting pressurised fluid and the extraction device of the dispensing machine are realised as respective nozzles provided with a pointed end that perforates a central zone respectively of the covering element and the base wall.

Alternatively, the capsule can also be inserted in a second type of dispensing machine, in which the base wall and the covering element are respectively perforated by an injection device for injecting pressurised fluid and by an extraction device of the dispensing machine. In these dispensing machines, the injection device comprises three blades configured to perforate the base wall. The extraction device instead comprises a plurality of pointed elements that, when a pressure of the fluid inside the capsule increases, engage with the covering element and perforate it in a plurality of different areas.

In the field of foodstuffs containers, following the request to differentiate the collection of solid urban waste, a need has recently emerged to dispose of the containers, once the containers have been used, by separating the components according to the material with which they are realised, in particular by separating the plastic or metallic material (aluminium) from the product contained therein.

In the case of the capsules for beverages described above, the casing is usually realised using a plastic material that is impermeable to liquids and gases, while the covering element, and optionally the further covering element, are made by means of an aluminium film or plastic film containing aluminium. There are therefore three different components with which the capsule is realised, each of which is to be disposed of separately with respect to the others.

The initial product contained in the capsule is a food product and is to be disposed of as organic waste, the casing is to be disposed of as plastic material while the covering element, and optionally the further covering element, if present, are to be disposed of as aluminium.

Capsules for beverages have therefore been proposed in which the casing is made of plastic material and the covering element is made by means of an aluminium film fixed by means of a detachable seal, for example a peelable seal, to a flanged rim of the capsule, such that after use, the different components can be separated to facilitate the user's differentiated disposal of the initial product, for example coffee, as organic waste.

The term detachable seal is intended as the fact that the film is removed from the casing to which it is sealed simply by pulling it. These films are also called “easy-peel”, or peelable films, and are a great advantage for the user who does not need scissors or knives to peel the aluminium film from the casing. The film is peelable thanks to a food-grade resin that is either extruded or placed in contact with the aluminium film.

The removal of the aluminium covering element after the use of the capsule is however increasingly more complex and difficult in relation to how much the covering element is torn by the extraction device of the dispensing machine during the dispensing of the final product. As was previously mentioned, upon completion of the dispensing, the extraction device in fact leaves one or more apertures in the covering element, whose size and position in the covering element depend on the extraction device itself.

A user can therefore face real difficulties in detaching the covering element from the casing in plastic material, as the covering element could further tear when placed under traction due to an attempt at detachment, releasing any remaining amount of the initial product, with consequent problems of hygiene and cleanliness.

The user could therefore be discouraged to detach the covering element when the dispensing is completed, and sometimes decide to simply dispose of the capsule as unsorted waste without separating the different components. Other times, the complete separation of the covering element from the casing could be truly difficult and the user might be forced to dispose of the casing and parts of the covering element sealed thereto as unsorted waste, despite having tried to separate the covering element, the same covering element having been torn in several parts with some portions still fixed to the flanged rim.

Capsules are more and more frequently spreading on the market whose outer casing and internal components, if present, are realised using a compostable material according to the harmonised standard of the European Committee UNI EN13432:2002. However, even in compostable capsules, the covering element is frequently realised using aluminium and is not in compostable material. The compostable material is in fact difficult for the injection devices to perforate, as well as the extraction devices of a dispensing machine designed to perforate covers in aluminium film or plastic film.

It follows that even in the compostable capsules, the user must detach the covering element in aluminium once the dispensing is completed, with the difficulties described above.

The technical object underlying the present invention is therefore that of providing a package comprising a single capsule, the package facilitating the user and allowing him or her to properly dispose of the capsule, separating the different components in an easy manner.

A further object of the present invention is to obtain a package comprising a single capsule which is easy to realise and of low cost.

In addition, the technical object underlying the present invention is also to provide a package comprising a plurality of capsules, the package facilitating the user and allowing him or her to properly dispose of each capsule, separating the different components in an easy manner.

A further object of the present invention is also to obtain a package comprising a plurality of capsules which is easy to realise and of low cost. According to a first aspect of the invention, these objects are achieved by the package in accordance with claim 1 and the claims dependent thereon.

According to a second aspect of the invention, these objects are achieved by the package according to the present invention in accordance with claim 8 and the claims dependent thereon.

Further characteristics and advantages of the present invention will become more apparent from the indicative, and hence non-limiting, description of a preferred, but not exclusive, embodiment of a package as illustrated in the appended drawings, in which:

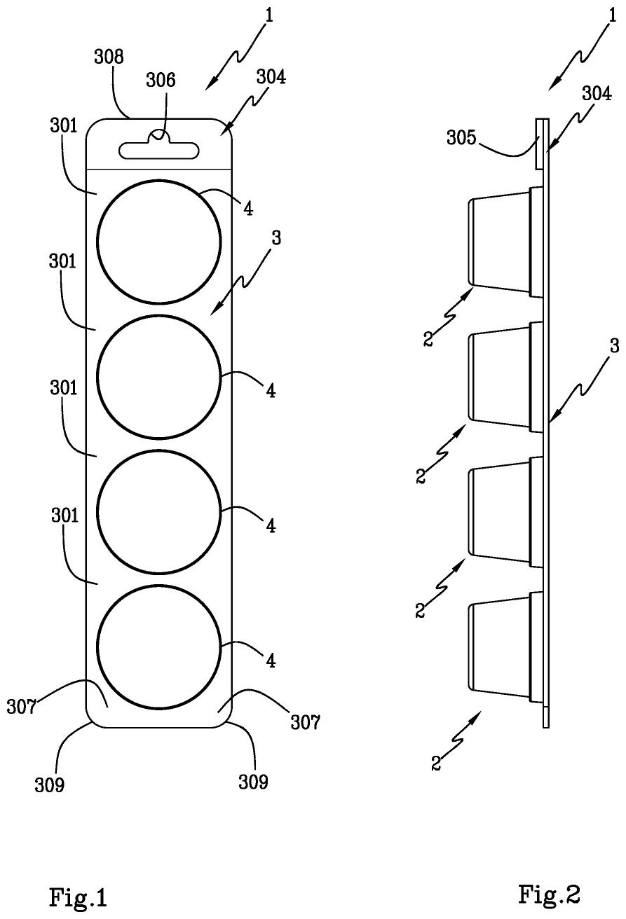

FIG. 1 shows a front view of a package comprising a plurality of capsules realised in accordance with the second aspect of the invention;

FIG. 2 shows a side view of the package of FIG. 1;

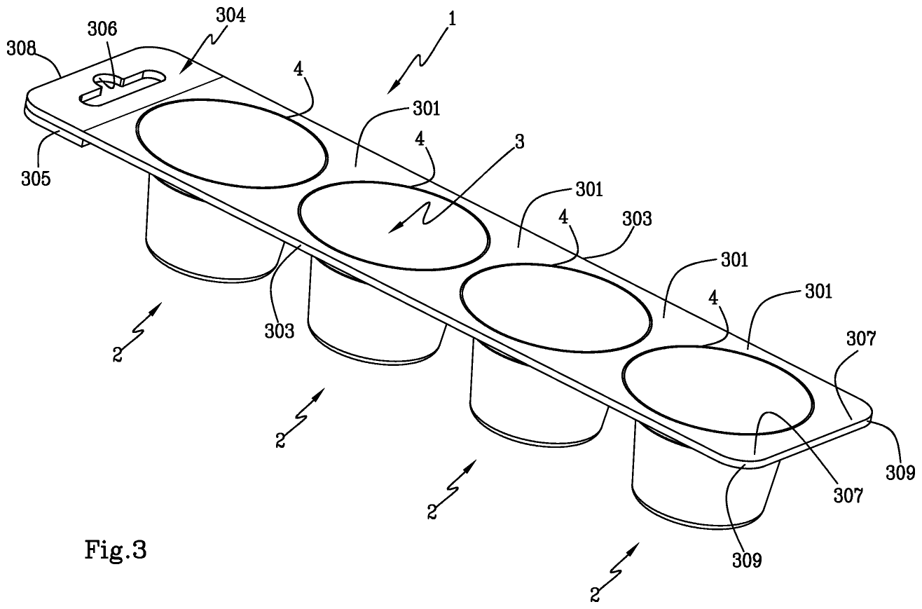

FIG. 3 shows an axonometric view of the package of FIG. 1;

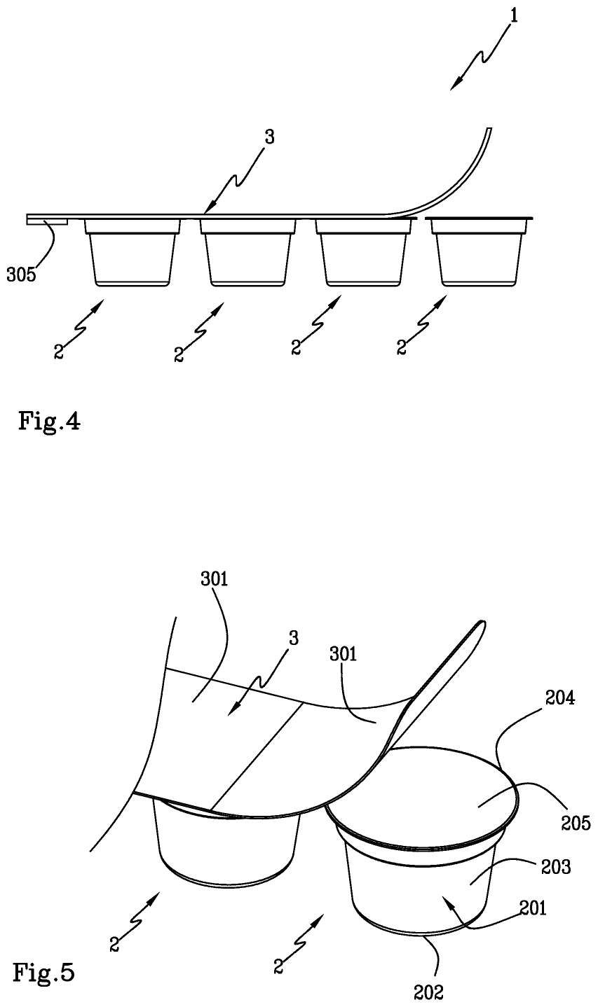

FIG. 4 shows a side view of the package of FIG. 1, in which a capsule has been detached in order to be used;

FIG. 5 shows a partial axonometric view, with parts removed for clarity, of the package of FIG. 4;

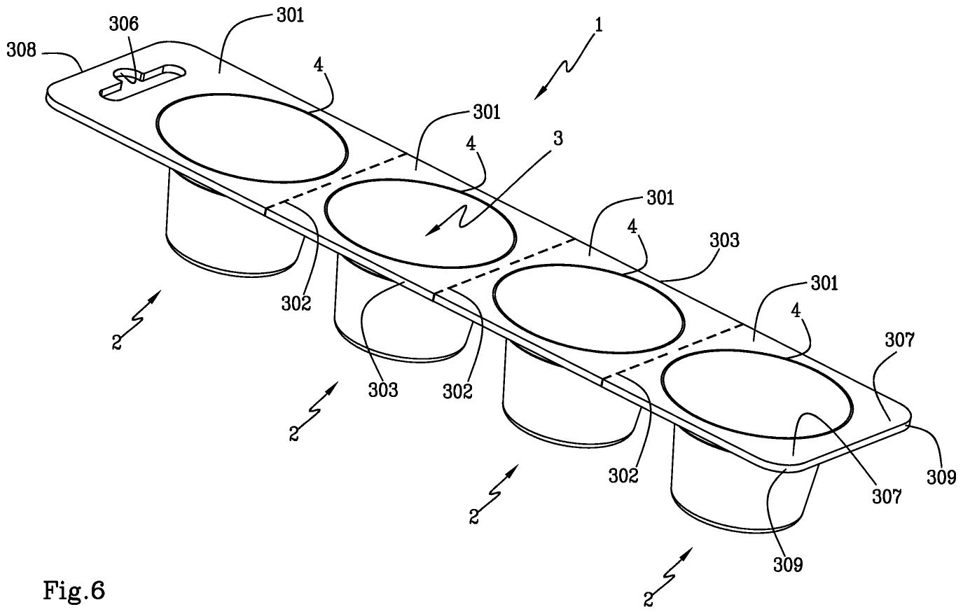

FIG. 6 shows an axonometric view of a variant of the package of FIG. 1;

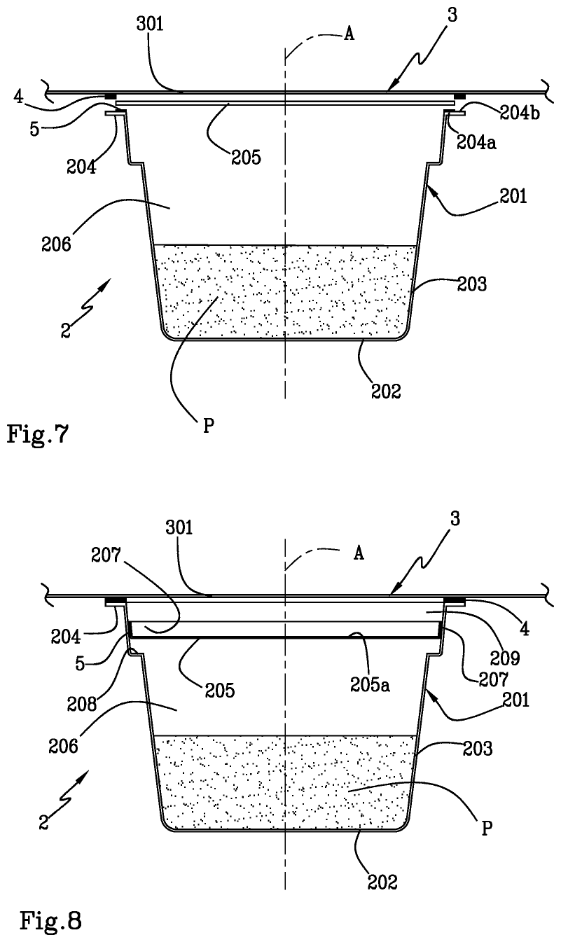

FIG. 7 shows a section of a capsule in accordance with the second aspect of the present invention which is part of the package of FIG. 1 or of FIG. 6, to which a covering element is detachably fixed, shown partially removed for reasons of clarity, in which the capsule comprises a filtering element fixed to a flanged rim;

FIG. 8 shows a section of a variant of the capsule of FIG. 7, in which the filtering element is fixed to an annular part of a side wall of the capsule;

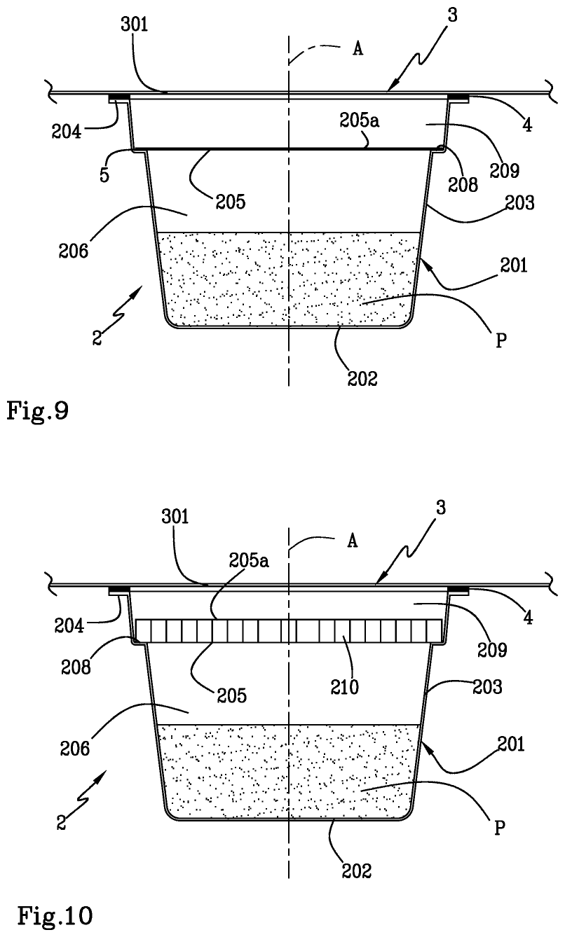

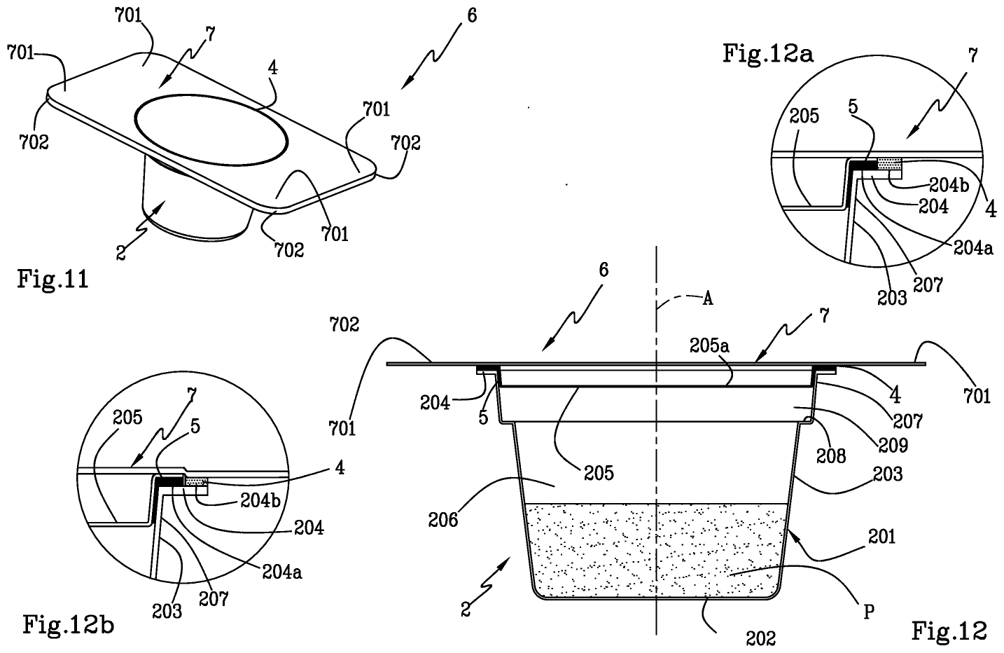

FIG. 9 shows a section of a variant of the capsule of FIG. 7, forming part of the package of FIG. 1, or of the variant of the package shown in FIGS. 11 and 12, in which the filtering element is fixed to a step of the side wall;

FIG. 10 shows a variant of the capsule of FIG. 7, in which the filtering element is a rigid body provided with openings, which is housed in a cavity and optionally positioned resting on the step and has a side edge, retained by interference in the side wall of the capsule;

FIG. 11 shows an axonometric view of a package realised in accordance with the first aspect of the present invention, which comprises a single capsule;

FIG. 12 shows a section view of the package of FIG. 11, in which a variant of the capsule of FIG. 7 is shown, in which the filtering element is fixed both to an internal portion of the flanged rim and the annular part of the side wall, contiguous to the flanged rim, and the covering element is fixed to an external portion of the flanged rim;

FIG. 12a shows an enlargement of the flanged rim of FIG. 12;

FIG. 12b shows a variant of the capsule of FIG. 12a.

In the following description, the same elements are indicated with the same reference numbers in the various figures.

With reference to the attached figures, the number 1 is used to indicate a package according to a second aspect of the invention, comprising a plurality of capsules 2.

Each capsule 2, as shown in detail in FIGS. 7 to 10, comprises a casing 201 having a longitudinal extension axis A, for example an axis of symmetry.

The casing 201 is preferably realised by means of injection moulding or thermoforming of a sheet material and is substantially in the shape of a truncated cone, i.e. in the form of a glass or cup. The casing 201 comprises a base wall 202 and a side wall 203, defining a cavity that is open, and a flanged rim 204, which extends from the side wall 203. The side wall 203 is divergent starting from the base wall 202 up to the flanged rim 204.

The base wall 202 is perforable respectively by injection means (not shown) or by extraction means (not shown) of a dispensing machine (not shown), in which each capsule 2 can be used. The dispensing machine is configured to dispense a final product (not shown).

Each capsule 2 further comprises a respective filtering element 205, the filtering element 205 delimiting a main chamber 206 in the cavity between the filtering element 205 itself and the base wall 202. In particular, the filtering element is associated with the cavity.

As it will be seen in detail below, the filtering element is associated with the cavity in that it is contained in the cavity and/or in that it is fixed to the flanged rim 204. Note also that the filtering element 205 can be fixed to the casing 201, detachably or not detachably; alternatively, the filtering element 205 can be retained by interference in the casing 201.

The main chamber 206 contains a respective initial product P (shown in FIGS. 7 to 10) to be combined with a fluid (not shown), preferably a pressurised hot liquid, introduced into the main chamber 206 to obtain a respective final product (not shown).

As previously mentioned, the initial product P is for example a soluble, freeze-dried, dehydrated, concentrated, percolatable, lyophilised, powdered food product—for example coffee—or in leaves—for example tea, to combine with water, preferably hot and pressurised, in order to obtain a final product such as a beverage, for example coffee, barley coffee, tea, or herbal tea.

The package 1 comprises a single covering element 3 which is detachably fixed, for example by means of a peelable seal 4, to the flanged rim 204 of each capsule to seal each cavity.

This covering element 3 therefore enables a user to detach a capsule 2 from the covering element 3 and allows its use in the dispensing machine. In particular, each capsule 2 can be detached from the covering element 3 independently from the remaining capsules 2, possibly still fixed to the covering element 3 itself.

Preferably, the casing 201 and the filtering element 205 are realised using a compostable material so as to enable the capsule 2 to be disposed of as organic waste after it has been used.

In detail, the casing 201 can be selected from one of the following materials of a first list:
Polyolefins (preferably PP or PE), polyethylene terephthalate (PET), polystyrene (PS), polylactic acid (PLA), polyethylene-furanoate (PEF);
Biodegradable and/or compostable materials other than PLA, for example of vegetable origin;
Recyclable materials (for example aluminium).

The above materials of the first list can be able to offer a barrier to oxygen and/or water.

The covering element 3 can comprise at least a layer comprising a material selected from one of the following materials of a second list:
PET;
PET comprising aluminium oxides and silicon oxides;
Aluminium;
PVDC;
PP;
PE;
PLA;
EVOH:
Paper;
Cellulose acetate.

In one embodiment, the covering element 3 can comprise at least two layers, in which each layer can comprise at least one of the materials of the second list (for example PET/PVDC, PET/aluminium).

In a further embodiment, the covering element 3 can comprise at least three layers, in which each layer can comprise at least one of the materials of the second list (for example PP/EVOH/PP, PP/EVOH/PE, PP/EVOH/PA).

The filtering element 205 can be selected from one of the following materials of a third list:
Polyolefins (non-woven fabric, preferably PP or PE), polyethylene terephthalate (PET), polystyrene (PS), polylactic acid (PLA), polyethylene-furanoate (PEF);
Biodegradable and/or compostable materials other than PLA, for example of vegetable origin;
Recyclable materials (for example aluminium).

The filtering element 205 can also be realised using filter paper.

If the casing 201 is realised by means of plastic material and the filtering element 205 is realised with a film of non-woven fabric, the filtering element 205 must preferably be detachable from the casing 201. Advantageously, owing to the package of the present invention, a user is forced to detach the capsule 2 from the covering element 3 before using the capsule 2 itself in the dispensing machine.

If the capsule 2 is entirely compostable, the user will be able to dispose of the entire capsule 2 as organic waste.

If instead the casing 201 is made of a non-compostable plastic material, the user can easily detach the filtering element 205 from the capsule 2, as the filtering element 205 itself is integral when the dispensing is completed, thus facilitating the disposal of the various components with which the capsule 2 is realised. As regards the possibility of realising a filtering element 205 that is easily detachable from a casing 201 in plastic material, see WO2014125440 of the same applicant, which is wholly incorporated herein for reference.

The capsule 2 can therefore be used advantageously in a dispensing machine of the type in which the covering element 3 interacts with a dispensing device of the dispensing machine, since the filtering element 205 associated with the capsule 2 allows the dispensing of a beverage, for example by means of percolation or infusion, and retains the initial product P itself when the dispensing is completed.

The covering element 3 comprises a plurality of covering zones 301, wherein each covering zone 301 is respectively fixed to a single capsule 2 by means of the peelable seal 4.

Between two adjacent covering zones 301 a detachment promoting element 302 is optionally present to allow a user, after having removed the capsule 2 from the respective covering zone 301, if desired, to separate the covering zone 301 itself from the covering element 3 using the detachment promoting element 302, to reduce a dimension of the covering element 3 following the use of a capsule 2. After having used a capsule 2, the package 1 reduces its dimensions and also the covering element 3, if the user prefers, can be reduced to make its dimension adjusted to the reduced dimension of the package 1.

It should be noted that the detachment promoting element 302 is placed in the covering element 3 at a part of the covering element 3 located between two capsules 2. The detachment promoting element 302 is for example a partially cut line, as shown in FIG. 6, which extends up to a side edge 303 of the covering element 3, preferably between opposite side edges 303. Alternatively, the detachment promoting element 302 can comprise a pair of “V”-shaped incisions (not shown) arranged at opposite edges of the covering element 3 and aligned to define a preferred tearing line that facilitates a user wishing to tear the covering element 3 itself. Optionally, the covering element 3 is provided with an end portion 304 and comprises a reinforcement part 305 arranged at said end portion 304. The reinforcement part 305 is provided with an opening 306 to enable the package 1 to be hung on a hook of a display unit (not shown).

The reinforcement part 305 enables the package 1 to be displayed, hung and offered for sale without requiring further packaging.

The covering element 3 comprises at least one gripping portion 307 which projects with respect to the edge of a capsule 2, to enable a user, by gripping the gripping portion 307, to detach a capsule 2 of the plurality of capsules 2 from the covering element 3.

The gripping portion 307 enables detaching the first capsule 2 from the covering element 3.

After having detached the first capsule 2 by means of the gripping portion 307, the entire covering zone 301, to which the capsule 2 was fixed (FIG. 5), can act as a further gripping portion 307 for detaching a second capsule 2 from the plurality of capsules 2.

Even if the detachment promoting element 302 is present, the position of the latter in the covering element 3 is suitably chosen in such a way that a gripping portion 307 is however present in each covering zone 301 to which a capsule 2 is still fixed. In other words, each covering zone 301 has larger dimensions than the dimensions of the flanged rim 204, to ensure the gripping portion 307 in each covering zone 301.

It should be noted that the gripping portion 307 and the reinforcement part 305 are distinct in the sense that, in the package, preferably, the reinforcement part 305 is arranged on the opposite part with respect to the gripping portion.

In detail, if the plurality of capsules 2 comprises two capsules 2, which are mutually aligned so as to define a row, the covering element 3 is preferably of elongate shape. The elongated element 3 therefore comprises a side 308, for example a smaller side, and at least two vertices 309, opposite the side 308.

The package 1 shown in FIGS. 1 to 3, 4 and 6 comprises, for example, four capsules 2 mutually aligned to define the row, the covering element 3 is of a rectangular shape, the reinforcement part 305 is arranged at the side 308, which is a shorter lateral side, while the gripping portion 307 is arranged at least at one of the vertices 309 delimiting the other shorter lateral side, opposite to the shorter lateral side 308.

As shown in FIG. 6 in the package 1 depicted, each edge 303 corresponds to a longer lateral side of the covering element 3.

If in addition the covering element comprises two gripping portions 307, such gripping portions 307 can be arranged at both said vertices 309. The user can thus begin to detach a capsule 2 from the covering element 3 starting from one of the two gripping portions 307.

According to a version of the package 1 not shown, the plurality of capsules 2 comprises four capsules 2, aligned two by two so as to define two rows, the row and a further row being placed side by side. If the covering element 3 is in the shape of a square, the four capsules 2 can for example be arranged at the vertices of the square. Again, as mentioned previously, the detachment promoting element can be present between two capsules 2 (not shown). For example, the detachment promoting element can be realised as two lines partially cut at right angles to each other, extending centrally between the side edges of the covering element, between the capsules 2.

According to a different version of the package 1, not shown, if the covering element 3 has a triangular shape and comprises at least one side 308 and at least one vertex 309, opposite said side, the reinforcement part can be arranged at the side and the gripping portion can instead be arranged at the vertex. Advantageously, the plurality of capsules can comprise three capsules, fixed to the covering element in an angularly equally spaced manner. Also in this case, the detachment promoting element (not shown) can be present between the capsules 2, for example realised as three partially cut lines that are incident with respect to each other, which extend from the vertices 309 towards the centre of the covering element 3.

It must be noted that the covering element 3 can be rectangular, square, triangular, or any other shape, without any general restrictions.

The arrangement of the capsules 2 in the package 1 can advantageously be arranged so as to be able to hold a plurality of packages 1 close together between them and reduce the overall dimensions of the plurality of packages 1.

According to another different version of the package 1, the reinforcement part 305 is absent, as shown in the package 1 of FIG. 6. In fact, if the package 1 is placed on a shelf, with the base wall 202 of each capsule 2 resting, the reinforcement part 305 is not necessary. Again, the package 1 can be displayed and offered for sale without requiring additional packaging because each capsule 2 is sealed by the covering element 3.

It was previously mentioned that the filtering element 205 is associated with the cavity of the capsule 2, so that it can be contained in the cavity and/or can be fixed to the flanged rim 204, and that it can be fixed to the casing 201 or retained by interference in the casing 201.

The filtering element 205 can be realised by means of a sheet material fixed in a non-detachable way, for example by ultrasonic sealing 5, to the casing 201 of the capsule 2. In this case, the filtering element 205 is preferably made of filter paper, or by means of a compostable, perforated sheet of plastic material, if the casing 201 is in a compostable material.

If the casing 201 is made of plastic material, the filtering element 205 is preferably realised using a sheet material of non-woven fabric containing fibres of synthetic and/or plastic material joined together and/or woven or overlapping, since the filtering element 205 must be preferably detachably fixed to the casing 201. As previously mentioned, the filtering element 205 is realised using one of the materials of the third list.

As shown in FIG. 7, the filtering element 205 can for example be fixed to the flanged rim 204, in an internal portion 204a of the flanged rim 204, preferably annular. In this case, the covering element 3 is fixed to the flanged rim 204, in an external portion 204b, preferably annular, of the flanged rim 204 itself. The external portion 204b can be contiguous to the internal portion 204a or it can be present in a central zone of the flanged rim 204, between the internal portion 204a and the external portion 204b, wherein the flanged rim 204 is not fixed to the covering element 3 nor to the filtering element 205.

Advantageously, by fixing the covering element 3 and the filtering element 205 to the same flanged rim 204 but in distinct annular portions, it is possible to remove the covering element 3 from the flanged rim 204 itself without risking tearing the filtering element 205, if the filtering element 205 is readily torn, for example because it is realised using filter paper or by means of the perforated sheet of compostable material.

According to an alternative embodiment of the capsule 2 (not shown), the covering element 3 is fixed to the flanged rim 204 by means of the interposition of the filtering element 205 between the covering element 3 and the flanged rim 204, if the filtering element 205 is made of non-woven fabric resistant to traction and comprises fibres of plastic material. In this case, the covering element 3 overlaps the filtering element 205 at the flanged rim 204.

Alternatively, the filtering element 205 can be fixed to an annular part 207 of the side wall 203 (FIG. 8), or if the side wall 203 is provided with an annular step 208 (FIG. 9), to said annular step 208. In these versions of the capsule 2 shown in FIGS. 8 and 9, the filtering element 205 is contained in the cavity.

The capsule 2 shown in FIGS. 12, 12a and 12b is illustrated in association with a different package 6, described later. However, it can also be fixed to the covering element 3 of the package 1 and is therefore described as a variant with respect to the other capsules already described.

As illustrated in FIG. 12, the filtering element 205 is fixed to the internal portion 204a of the flanged rim 204, as in the capsule 2 illustrated in FIG. 7, but the filtering element 205 is also fixed to the annular part 207 of the side wall 203, contiguous to the flanged rim 204, as in the capsule 2 illustrated in FIG. 8. In this case, the covering element is fixed to the flanged rim 204, in the external portion 204b of the flanged rim 204 itself, as in the capsule 2 of FIG. 7. In this version, the filtering element 205 is contained in the cavity and is fixed to the flanged rim 204.

In FIG. 12a, it should be noted that the external portion 204b is contiguous to the internal portion 204a. In FIG. 12b, it should be noted that a central zone of the flanged rim 204 is present, between the internal portion 204a and the external portion 204b, wherein the flanged rim 204 is not fixed to the covering element 3 nor to the filtering element 205.

Fixing the filtering element 205 to both the internal portion 204a and the annular part 207 reduces the possibility that the filtering element 205 can detach, if the filtering element 205 is fixed in a non-detachable way. According to a different embodiment, the filtering element 205 is realised as a filtering body (FIG. 10), which is rigid and provided with openings 210. The filtering body 205 is, for example, an annular disc which is provided with a peripheral edge configured to abut the side wall 203 by interference in order to be retained by interference in the capsule 2.

If the side wall 203 is provided with the annular step 208, in addition to the main chamber 206, a secondary chamber 209 is defined between the annular step 208 and the flanged rim 204. The filtering body 205 can optionally be resting on the annular step 208. In this version, the filtering element 205 is contained in the cavity and is entirely housed inside the secondary chamber 209.

In relation to the position of the filtering body 205 in the side wall 203 and/or the position of the annular step 208 in the side wall 203, the dimensions of the main chamber 206 and the secondary chamber 209 can change and, consequently, the position of the filtering body 205 in the cavity can change.

Both when the filtering element 205 is realised using a material in sheet form, and when the filtering element 205 is realised as a rigid filtering body, the distance between the flanged rim 204 and a surface 205a of the filtering body 205, facing the flanged rim 204, depends on the position of the annular step 208 and/or a thickness of the filtering body 205.

If the filtering element 205 is in non-woven fabric material or filter paper, the thickness of the filtering element 205 is reduced and the surface 205a corresponds to that of the annular step 208.

If the filtering element 205 is fixed to the flanged rim 204, the main chamber 206 has the same dimension as the cavity inside the capsule 2 and the secondary chamber has a dimension which is substantially null. If instead the filtering element 205 is fixed to the annular step 208, or to the annular part 207, the dimension of the secondary chamber 209 depends on the position in which the filtering element 205 is fixed.

If instead the filtering element 205 is a filtering body of rigid material having a thickness which is not reduced, the surface 205a is distinct from that of the annular step 208. If of interest, the surface 205a can be aligned with the flanged rim 204 or a space can be left, inside the secondary chamber 209, between the surface 205a and the flanged rim 204 itself.

In both cases, it can for example be advantageous to collect the final product in the space between the filtering element 205 and the flanged rim 204, if the base wall 202 of the capsule 2 is perforated by the injection device of the dispensing machine.

The filtering element 205 is preferably realised using rigid compostable material, if the casing 201 is in a compostable material.

According to a variant not shown, the capsule 2 comprises a further filtering element, contained in the cavity, arranged between the base wall 202 and the filtering element 205. The main chamber containing the product P is therefore defined between the filtering element and the further filtering element, to leave an extra space between the further filtering element and the base wall 202. Advantageously, a capsule with a filtering element and a further filtering element can dispense the final product in both dispensing machines in which the injection device perforates the base wall and in dispensing machines in which the injection device is housed in the secondary chamber 209 and the dispensing device perforates the base wall 202.

In use, a user separates a capsule 2 from the package 1, taken from a display unit in which it is hung at the end portion 304 wherein the reinforcement part 305 is present, detaching the capsule 2 from the covering element 3, using the gripping portion 307 arranged at a vertex 309 of the covering element 3.

If the filtering element 205 is made of a material in sheet form or in filter paper and is fixed inside the cavity of the capsule 2, on the annular step 208 or to the annular part 207, or to the internal portion 204a of the flanged rim 204, the filtering element 205 is contained in the capsule 2 and is not affected by the fact that the covering element 3 is placed in traction, detaching itself from the flanged rim 204.

Each detached capsule 2 therefore always remains intact and ready to be used in a dispensing machine. For example, the base wall 202 of the capsule 2 can be perforated by the injection device of the dispensing machine.

The product P is combined with a pressurised liquid in the main chamber 206 and a beverage is created in the latter which, filtered by the filtering element 205, comes to be dispensed in the secondary chamber 209 to then be output into a container of a user.

Owing to the package 1 according to the present aspect of the invention, which comprises a plurality of capsules 2, a user is guaranteed, before using a capsule 2 in a dispensing machine, that the capsule will separate from the covering element 3 without any risk of tearing the covering element 3, thus allowing each component of the capsule 2 to be properly disposed of. The covering element 3, comprising at least one layer realised using one of the materials of the second list, can easily be disposed of separately from the capsule 2.

Owing to the fact that each capsule 2 of the package 1 contains a filtering element 205, fixed to the casing 201, or retained by interference in the casing 201, the initial product P to be combined with a pressurised fluid is contained in a main chamber 206 defined between the base wall 202 and the filtering element 205 itself and therefore the final product can be collected in a secondary chamber 209 defined between the filtering element 205 and the flanged rim.

It follows that the capsule 2 of the invention does not only have the same functionality of the capsules 2 already known to operate in the dispensing machines of known type but allows avoiding the use of further additional packages in cardboard, thereby reducing the waste arising from the use of the package 1 itself. The package 1 is also easily feasible and low-cost to manufacture.

In accordance with a first aspect of the present invention illustrated in FIGS. 11, 12, 12a and 12b, a package 6 is herein proposed that differs from package 1, previously described, for the fact that the package 6 comprises only one capsule 2 for beverages.

The capsule 2 included in the package 6 and shown in FIGS. 12, 12a and 12b has already been previously described. A filtering element 205 is realised using a material in sheet form and is fixed, for example in a non-detachable way as previously illustrated, both to a flanged rim 204, in detail to an internal portion 204a of the flanged rim 204, and to an annular part 207, contiguous to the flanged rim 204. In the cavity, the filtering element 205 defines the main chamber 206 between the filtering element 205 and the base wall 202, which contains an initial product P to be combined with the fluid in order to obtain the final product.

The capsule 2 of FIGS. 12, 12a and 12b is provided only by way of example in the package 6 and it must be noted that the package 6 can comprise any type of capsule 2, previously described with reference to FIGS. 7 to 10, in which the filtering element 205 can be associated with the cavity, in that it is contained in the cavity and/or fixed to the flanged rim 204, and fixed to the casing 201 or retained by interference in the casing 201. For the sake of brevity, the capsule 2 is thus not described again in full but reference is made to what has already been previously described. The capsule 2 can be used in a dispensing machine and, in detail, the capsule 2 can be inserted in a seat of the dispensing machine, for example in a percolation chamber, i.e. in a chamber in which the final product is obtained.

The package 6 comprises a covering element 7 which is detachably fixed, for example by means of a respective peelable seal 4, to the flanged rim 204 of the capsule 2 to seal the cavity of the capsule 2. Again for the sake of brevity, the details of a peelable seal already previously described are not repeated here.

In order to be able to use the capsule 2 in the dispensing machine, the user must detach the covering element 7 from the flanged rim 4. For this purpose, the covering element 7 comprises at least one respective gripping portion 701 projecting with respect to the flanged rim 204, to enable a user, by gripping the gripping portion 701, to detach a capsule 2 from the covering element 7.

The gripping portion 701 is arranged, as shown for example in FIG. 11, at least at one vertex 702 of the covering element 7 or preferably, if the covering element 7 is rectangular, at the four vertices 702.

Advantageously, the presence of the detachable covering element 7, which is provided with the gripping portion 701 and the simultaneous presence of the filtering element 205 associated with the cavity of the capsule 2, fixed to the casing 201 or retained by interference in the casing 201, enables realising a very simple package 6 in which the capsule 2 is usable in a dispensing machine and at the same time the covering element 7 can never be torn by the injection device or extraction device of the dispensing machine. In fact, the user is forced to detach the covering element 7 itself before using the capsule 2.

To avoid the possibility that the user inserts the capsule 2 in the dispensing machine without having previously removed the covering element 7, the covering element 7 has dimensions that are not only greater than the flanged rim 204 but also has larger dimensions than a maximum dimension of a mouth of the seat of the dispensing machine.

The covering element 7 is therefore appropriately designed, in its shape or overall dimensions, so that the package 6 comprising the capsule 2 and the covering element 7 as a whole has overall dimensions that do not fit in the seat of the dispensing machine in which it is intended.

If the package 6 is considered, and a covering element 7 is considered of such a size that allows the covering element not to fit into the seat of the dispensing machine and at the same time to be able to be detachably fixed to a further capsule 2, it should be noted that it is possible to obtain the package 1 of FIGS. 1 to 6 comprising a plurality of capsules 2. Optionally, as previously mentioned, the covering element 7 can comprise a reinforcement part (not shown) arranged at an end portion thereof (not shown); said reinforcement part being provided with an opening (not shown) to enable the package 6 to be hung on a hook of a display unit.

It should be added that all of what has been mentioned above in relation to the material with which the casing 201 of the capsule 2 is realised, chosen among one of the materials of the first list, and the filtering element 205 inside the capsule 2 chosen among one of the materials of the third list, also applies in the case of the package 6. In other words, it can be applied that which was previously mentioned in relation to the material with which the covering element 7 is realised, wherein at least one layer is realised in one of the materials of the second list.

Similarly to that which was previously described with reference to the package 1, also in this case the user is forced to detach the covering element 7 from the flanged rim 4, since the package 6 has dimensions which are incompatible with the mouth of the seat of the dispensing machine itself.

Advantageously, again, the capsule 2, that is, both the casing 201 and the filtering element 205, can be realised using a compostable material in order to dispose of the capsule 2 as organic waste after it has been used. In use, a user separates the covering element 7 from the capsule 2 from the package 6, detaching the capsule 2 from the covering element 7, using the gripping portion 701 arranged in the corner 702.

Owing to the package 6 according to the first aspect of the present invention, a user is guaranteed, before using a capsule 2 in a dispensing machine, that the capsule will separate from the covering element 7 without any risk of tearing the covering element 7, thus allowing each component of the capsule 2 to be properly disposed of. A suitably designed dimension of the covering element 7, advantageously, forces a user to detach the covering element 7 itself from the package 6 and promotes the correct use of the capsule 2 in the dispensing machine.

What stated above in relation to the package 1 comprising a plurality of capsules 2, also applies to the package 6 comprising a single capsule 2. Since the capsule 2 of the package 6 has been suitably designed to operate in the dispensing machines of known type, the package 6 comprising a single capsule 2 ensures in a very simple and low-cost way the possibility of properly disposing of each component with which the package 6 is realised.

1. A package (6) comprising a single capsule (2), wherein the capsule (2) comprises:
a casing (201) having a longitudinal extension axis (A), in turn comprising a base wall (202) and a side wall (203) defining a cavity, and a flanged rim (204) extending from said side wall (203); wherein said base wall (202) is perforable respectively by injection means or by extraction means of a dispensing machine of a final product in which said capsule (2) can be used, said capsule (2) being insertable in a seat of the dispensing machine;
a filtering element (205) associated with the cavity, the filtering element (205) delimiting in the cavity a main chamber (206) between said filtering element (205) and said base wall (202), wherein said main chamber (206) is configured to contain a respective initial product (P) to be combined with a fluid in order to obtain a respective final product; and wherein said package (6) comprises
a covering element (7) detachably fixed, for example by means of a peelable seal (4), to the flanged rim (204) of the capsule (2) so as to seal the cavity, the covering element (7) having greater dimensions than the flanged rim (204) and comprising at least a respective gripping portion (701) projecting with respect to the flanged rim (204), so as to enable a user, by gripping said gripping portion (701), to detach the capsule (2) from the covering element (7) of the package (6) and allow use of said capsule (2) in the dispensing machine; and wherein
the covering element (7) has larger dimensions than a maximum dimension of a mouth of the seat of the dispensing machine, so that a user is forced to detach the covering element (7) from the flanged rim (204) of the capsule (2) in order to be able to insert the capsule (2) in said seat.

2. The package according to claim 1, wherein the filtering element (205) is realised using a sheet material fixed, for example by welding (5), preferably ultrasound welding, to an internal portion (204a) of the flanged rim (204) and wherein the covering element (7) is fixed by said detachable seal (4) to an external portion (204b) of the flanged rim (204).

3. The package according to claim 1, wherein the filtering element (205) is realised using a sheet material and is fixed, for example by welding (5), preferably ultrasound welding, to an annular part (207) of the side wall (203) or, if said side wall (203) is provided with an annular step (208), to said annular step (208).

4. The package according to claim 2, wherein the filtering element (205) is realised using a sheet material and is fixed, for example by welding (5), preferably ultrasound welding, to an annular part (207) of the side wall (203) or, if said side wall (203) is provided with an annular step (208), to said annular step (208), wherein the annular part (207) is contiguous to said internal portion (204a).

5. The package according to claim 1, wherein the filtering element (205) is a rigid body provided with openings (210) housed in the cavity, which is provided with a peripheral edge configured to abut said side wall (203) by interference in order to be retained by interference in the capsule (2), and optionally wherein the side wall (203) is provided with an annular step (208), configured to define a secondary chamber (209) between said annular step (208) and said flanged rim (204), said filtering element (205) resting on said annular step (208).

6. The package according to claim 1, wherein said casing (201) and said filtering element (205) are made of a compostable material so as to enable said capsule (2) to be disposed of as organic waste after having been used.

7. The package according to claim 1, wherein said covering element (7) is provided with an end portion and comprises a reinforcement part arranged at said end portion; said reinforcement part being provided with an opening to enable said package (6) to be hung on a hook of a display unit.

8. A package (1) comprising a plurality of capsules (2), wherein each capsule (2) comprises:
a casing (201) having a longitudinal extension axis (A), in turn comprising a base wall (202) and a side wall (203) defining a cavity, and a flanged rim (204) extending from said side wall (203); wherein said base wall (202) is perforable respectively by injection means or by extraction means of a dispensing machine of a final product in which the capsule (2) can be used;
a filtering element (205) associated with said cavity, the filtering element (205) delimiting in the cavity a main chamber (206) between said filtering element (205) and said base wall (202), wherein said main chamber (206) is configured to contain a respective initial product (P) to be combined with a fluid in order to obtain a respective final product; and wherein said package (1) comprises a single covering element (3); said covering element (3) being detachably fixed, for example by means of a peelable seal (4), to each flanged rim (204) of each capsule (2) so as to seal each cavity, such as to enable a user to detach a capsule (2) from the covering element (3) of the package (1) and allow use of said capsule (2) in the dispensing machine.

9. The package according to claim 8, wherein the covering element (3) comprises a plurality of covering zones (301), separated from one another by a detaching element (302), wherein each covering zone (301) is fixed respectively to a single capsule (2) to enable a user, after having removed the capsule (2) from the respective covering zone (301), to separate the covering zone (301) itself from the covering element (3) using the detaching element (302) to reduce a dimension of the covering element (3) following use of a capsule (2).

10. The package according to claim 8, wherein said covering element (3) is provided with an end portion (304) and comprises a reinforcement part (305) arranged at said end portion (304); said reinforcement part (305) being provided with an opening (306) to enable said package (1) to be hung on a hook of a display unit.

11. The package according to claim 8, wherein the covering element (3) comprises at least a gripping portion (307) projecting with respect to the flanged rim (204) of a capsule (2), in order to enable a user, by gripping said gripping portion (307), to detach said capsule (2) from said covering element (3).

12. The package according to claim 10, wherein the covering element (3) comprises at least a gripping portion (307) projecting with respect to the flanged rim (204) of a capsule (2), in order to enable a user, by gripping said gripping portion (307), to detach said capsule (2) from said covering element (3), wherein the gripping portion (307) and the reinforcement part (305) are distinct.

13. The package according to claim 10, wherein the plurality of capsules (2) comprises two capsules (2), which are aligned to one another to define a row, and wherein the covering element (3) has an elongate shape and comprises a side (308) and at least two vertices (309), opposite said side (308), the reinforcement part (305) being arranged at said side (308), the gripping portion (307) being arranged at least at one of said vertices (309); and wherein, in addition, if the covering element (3) comprises two gripping portions (307), said gripping portions (307) are preferably arranged at both said vertices (309).

14. The package according to claim 13, wherein the plurality of capsules (2) comprises four capsules (2), aligned two by two so as to define two rows, the row and a further row being placed side by side.

15. The package according to claim 12, wherein the covering element (3) has a triangular shape and comprises a side and at least a vertex, opposite said side, the reinforcement part being arranged at said side, the gripping portion being arranged at said vertex; and wherein the plurality of capsules comprises three capsules fixed to the covering element, which are angularly equally spaced.

16. The package according to claim 8, wherein the filtering element (205) is realised using a sheet material fixed, for example by welding (5), preferably ultrasound welding, to an internal portion (204a) of the flanged rim (204) and the covering element (3) is fixed by said peelable seal (4) to an external portion (204b) of the flanged rim (204).

17. The package according to claim 8, wherein the filtering element (205) is realised using a sheet material and is fixed, for example by welding (5), preferably ultrasound welding, to an annular part (207) of the side wall (203) or, if said side wall (203) is provided with an annular step (208), to said annular step (208).

18. The package according to claim 16, wherein the filtering element (205) is realised using a sheet material and is fixed, for example by welding (5), preferably ultrasound welding, to an annular part (207) of the side wall (203) or, if said side wall (203) is provided with an annular step (208), to said annular step (208), wherein said annular part (207) is contiguous to said internal portion (204a).

19. The package according to claim 8, wherein the filtering element (205) is a rigid body provided with openings (210) housed in the cavity, which is provided with a peripheral edge configured to abut said side wall (203) by interference in order to be retained by interference in the capsule (2), and optionally wherein the side wall (203) is provided with an annular step (208), configured to define a secondary chamber (209) between said annular step (208) and said flanged rim (204), said filtering element (205) being housed in said secondary chamber (209) and resting on said annular step (208).

20. The package according to claim 8, wherein said casing (201) and said filtering element (205) are made of a compostable material to enable said capsule (2) to be disposed of as organic waste after having been used.
